(19) United States
(12) Patent Application Publication
(10) Pub. No.: US 2007/0097545 A1
(43) Pub. Date: May 3, 2007

(54) Disk damper and hard disk drive having the same

(75) Inventors: Yongchul Yoo, Suwon-si (KR); Jun-young Lee, Yongin-si (KR); Sungwook Kang, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/591,562

(22) Filed: Nov. 2, 2006

(30) Foreign Application Priority Data
Nov. 3, 2005 (KR) 2005-104930

(51) Int. Cl. G11B 17/02; G06F 1/16

(52) U.S. Cl. 360/99.12; 361/685

(57) ABSTRACT

A disk damper to reduce the vibration of a HSA (head stack assembly) by air flow caused by rotation of a disk, and a HDD (hard disk drive) having the same. The disk damper includes a front end positioned relatively far from the HSA and a rear end positioned relatively close to the HSA, and a first flow channel inducing the air flow caused by the rotation of the disk from the front end to the rear end through the inside of the disk damper.

### CROSS-REFERENCE TO RELATED APPLICATIONS

This application claims the benefit of Korean Patent Application No. 10-2005-0104930, filed on Nov. 3, 2005, in the Korean Intellectual Property Office, the disclosure of which is incorporated herein in its entirety by reference.

### BACKGROUND OF THE INVENTION

1. Field of the Invention

The present general inventive concept relates to a hard disk drive (HDD), and more particularly, to a disk damper which reduces vibration of a head stack assembly (HSA) by air flow caused by rotation of a disk, and a HDD having the same.

2. Description of the Related Art

A hard disk drive (HDD) is an example of an auxiliary memory used in computers, MP3 players, mobile phones, and so on to record data on a disk-shaped data storing medium or to read the data recorded using a slider with a magnetic head.

FIG. 1 is a plan view illustrating an example of a conventional HDD.

With reference to FIG. 1, the conventional HDD 10 includes a disk 20 as a data storing medium, a spindle motor 15 rotating the disk 20 at high speed, and a head stack assembly (has) 25 in a housing including a base 11 and a cover (not shown) coupled to the base 11. A slider 27 having a magnetic head (not shown) for recording and reading data is mounted on the front end of the HSA 25, and the HSA 25 records data on the disk 20 or reads the data recorded on the disk 20 by moving the slider 27 to a predetermined position on the disk 20.

When the disk 20 rotates at high speed on the base 11, a lift force acts on the slider 27. The slider 27 floats at a predetermined height where the lift force is equal to the elastic pressing force of the front end of the HSA 25 toward the disk 20. The magnetic head (not shown) on the slider 27 floating at the predetermined height reproduces or records data on the disk 20.

The HDD 10 includes a disk damper 30 controlling the vibration of the disk 20 caused by the high-speed rotation of the disk 20. The disk damper 30 has an alphabet character “C” shape so as not to interrupt the movement of the HSA 25. When a plurality of disks 20 are included in the HDD 10, the disk damper 30 is inserted, at a predetermined space, between the disks 20 so that the disks 20 do not collide with each other. When a single disk 20 is included in the HDD 10, the disk damper 30 is inserted between the cover (not shown) and the disk 20 so that the cover does not collide with the disk 20.

To connect a flexible printed circuit (FPC) connected with the HSA 25 to a main circuit substrate (not shown) under the base 11, a FPC bracket 35 is operatively positioned on the base 11. To filter alien substances, such as particles, from the air inside the HDD 10, a circulating filter 40 is operatively positioned diagonally relative to the FPC bracket 35.

In the conventional HDD 10, the air flow flows counter-clockwise along the disk 20 rotating counter-clockwise and flows into a front end 31 of the disk damper 30, and it flows between the disk damper 30 and the disk 20 and flows out through the rear end 32 of the disk damper 30. When the air flow flowing out through a rear end 32 of the disk damper 30 exits the disk damper 30, the width of the air flow suddenly increases, and the flow disturbance of the air at a wake region T adjacent to the rear end 32 increases. Thus, there is a problem of increasing the vibration of the HSA 25 due to the increase in the flow disturbance.

Moreover, since the air flow toward the circulating filter 40 is controlled by the disk damper 30, there is another problem of reducing the particles-collecting efficiency by the circulating filter 40.

### SUMMARY OF THE INVENTION

The present general inventive concept provides a disk damper having an improved structure to control the flow disturbance of air at a wake region adjacent to the rear end of the disk damper, and a hard disk drive (HDD) having the same.

Additional aspects and advantages of the present general inventive concept will be set forth in part in the description which follows and, in part, will be obvious from the description, or may be learned by practice of the general inventive concept.

The foregoing and other aspects of the present inventive concept may be achieved by providing a disk damper which is spaced, at a predetermined interval, from a disk in a hard disk drive (HDD) and positioned so as to control a head stack assembly (HSA) not to interrupt the movement of the HSA such that vibration of a rotating disk can be controlled, the disk damper comprising a front end positioned to be relatively far from the HSA, a rear end positioned to be relatively close to the HSA, and a first flow channel to induce the air flow caused by a rotation of the disk from the front end to the rear end through the inside.

The first flow channel may be formed of a plurality of pipes to bend along a concentric circular arc having a same center as the rotation center of the disk.

The plurality of pipes may have a same square or hexagonal section size, respectively.

The inside of the disk damper may be filled with a porous material permitting ventilation therethrough, and the first flow channel may be formed through the porous material.

The porous material may be woven or non-woven fabric.

The disk damper may further include a second flow channel inducing the air flow caused by the rotation of the disk from the front end to a circulating filter positioned outside the circumference of the disk.

The foregoing and other aspects of the present inventive concept may also be achieved by providing an HDD which includes at least one disk as a data storing medium, an HSA to move a magnetic head that stores or reads out data to a specific position on a rotating disk, and a disk damper to control the vibration of the rotating disk and spaced, at a predetermined interval, from the disk and positioned so as to avoid the HSA not to interrupt a movement of the HSA, wherein the disk damper includes a front end positioned to be relatively far from the HSA, a rear end positioned to be relatively close to the HSA, and a first flow channel inducing the air flow caused by the rotation of the disk, from the front end to the rear end through the inside of the disk damper.

The first flow channel may be formed of a plurality of pipes to bend along a concentric circular arc having a same center as the rotation center of the disk.

The plurality of pipes may have a same square or hexagonal section size, respectively.

The inside of the disk damper may be filled with a porous material permitting ventilation therethrough, and the first flow channel may be formed through the porous material.

The porous material may be woven or non-woven fabric.

The HDD may further include a circulating filter to filter foreign materials contained in the air outside the disk, and the disk damper may further include a second flow channel inducing the air flow caused by the rotation of the disk from the front end to the circulating filter.

In an embodiment, a plurality of disks are stacked and the disk damper is inserted between two disks adjacent to each other.

In an embodiment, one disk is used and the disk damper is positioned above the disk.

The foregoing and other aspects of the present inventive concept may also be achieved by providing a hard disk drive comprising a disk damper disposed to control vibration of a disk, and having an front end formed with a front opening to receive air, and a rear end formed with a rear opening to output the air, and an intermediate end formed with one or more apertures and formed between the front end and the rear end to output the air to a portion between the front end and the rear end.

The foregoing and other aspects of the present inventive concept may also be achieved by providing a hard disk drive having a disk damper disposed to control an air flow around a disk, and having an front end formed with a front opening to receive air, and a rear end formed with a rear opening to output the air, one or more pipes formed between the front end and the rear end, and one or more apertures formed on at least one of the one or more pipes between the front end and the rear end.

The foregoing and other aspects of the present inventive concept may also be achieved by providing a hard disk drive having a disk damper disposed to control an air flow generated from a rotation of a disk, and having a front end formed with a front opening, a rear end formed with a rear opening, one or more front pipe connected with the front end to receive air from the front opening to form one or more front air passages, one or more rear pipes connected with the rear opening of the rear end to form one or more rear air passages, and one or more apertures disposed between the one or more front pipes and the one or more rear pipes to guide the air from the one or more front pipes to an intermediate end between the front end and the rear end.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a plan view illustrating an example of a conventional HDD (hard disk drive);

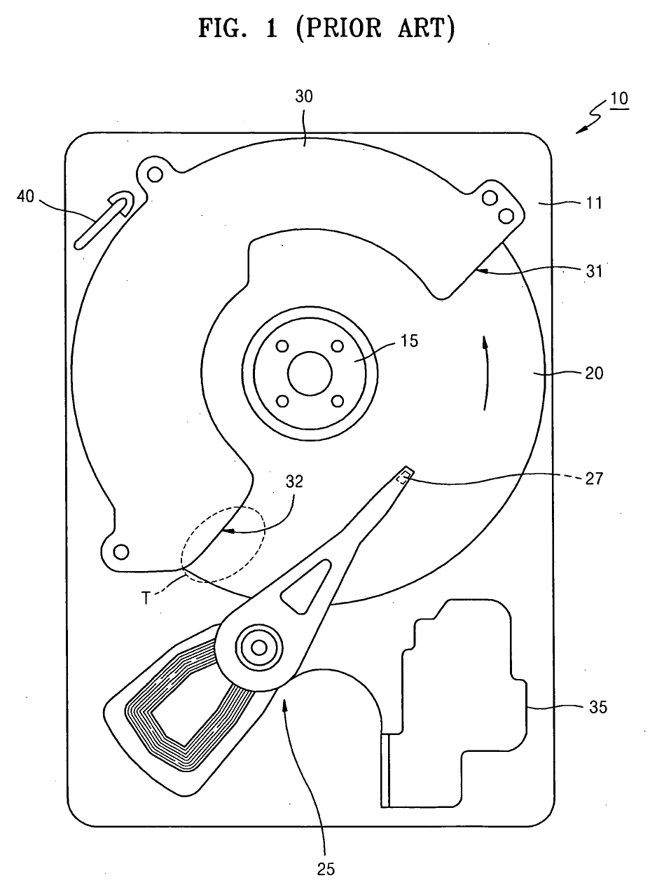

FIG. 2 is an exploded perspective view illustrating an HDD according to an embodiment of the present general inventive concept;

FIG. 3 is a cross-sectional view illustrating a disk damper according to an embodiment of the present general inventive concept;

FIG. 4 is a vertical sectional view illustrating the disk damper taken along the line IV-IV of FIG. 3;

FIG. 5 is a cross-sectional view illustrating a disk damper according to another embodiment of the present general inventive concept;

FIG. 6 is a cross-sectional view illustrating a disk damper according to another embodiment of the present general inventive concept; and

FIG. 7 is a vertical-sectional view illustrating the disk damper taken along the line IV-IV of FIG. 6.

### DETAILED DESCRIPTION OF THE PREFERRED EMBODIMENTS

A Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A disk damper and a hard disk drive (HDD) having the same according to various embodiments of the present general inventive concept will now be described more fully with reference to the accompanying drawings.

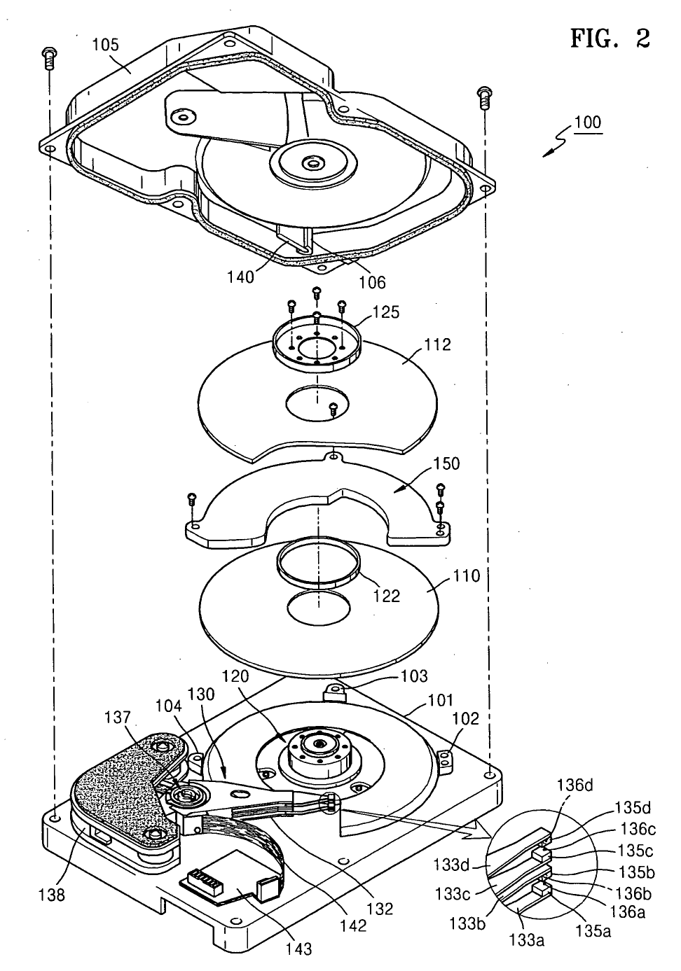

FIG. 2 is an exploded perspective view illustrating an HDD according to an embodiment of the present general inventive concept.

With reference to FIG. 2, the HDD 100 includes a housing having an inner space formed by coupling a base 101 and a cover 105. The housing includes first and second disks 110 and 112, a spindle motor 120, an HSA (head stack assembly) 130, a VCM (voice coil motor) 138, and a disk damper 150.

The housing comprises the base 101 to support the spindle motor 120 and the HSA 130, and the cover 105 to protect the disks 110 and 112 and coupled to an upper part of the base 101. The base 101 and the cover 105 are usually made of stainless steel or aluminium materials. However, other materials that provide the intended purposes described herein may be used alternatively.

The fist and second disks 110 and 112 are positioned inside the housing. Four or more disks can be positioned in the HDD 100 to increase the data storage capacity. However, as the surface recording density of a disk has been remarkably increased, it is possible to store a sufficient data storage capacity with only one or two disks. Thus, recently the HDD with only one or two disks is usually used.

The spindle motor 120 to rotate the first and second disks 110 and 112 is fixedly installed on the base 101. A ring-shaped spacer 122 to maintain a space between the first and second disks 110 and 112 is inserted between the two disks 110 and 112. A disk clamp 125 to prevent the disks 110 and 112 from coming loose is coupled at an upper end of the spindle motor 120.

The HSA 130 as a unit to record data on the disks 110 and 112 or read out the data recorded on the disks 110 and 120 is pivotably positioned on the base 101. The HSA 130 includes a swing arm 132 pivotably coupled around a pivot bearing 137, first, second, third and forth suspensions 133a, 133b, 133c and 133d coupled with the front of the swing arm 132, and first, second, third and fourth sliders 135a, 135b, 135c and 135d supported by the suspensions 133a, 133b, 133c and 133d, respectively. First, second, third and fourth magnetic heads 136a, 136b, 136c and 136d to record and reproduce the data are formed on the sliders 135a, 135b, 135c and 135d, respectively.

The VCM 138 to provide a pivoting force to drive the HSA 130 is controlled by a servo control system and rotates the HSA 130 in a direction according to Fleming's Left Hand Rule by the interaction between a current input in the VCM coil (not shown) at the rear end of the HSA 130 and a magnet (not shown) of the VCM 138. Thereby, the four sliders 135a, 135b, 135c and 135d attached to the front end of the suspensions 133a, 133b, 133c and 133d, respectively, move toward the spindle motor 120 or outer circumferences of the first and second disks 110 and 112 from main data surfaces of the disks 110 and 112.

The disk damper 150 to control vibration and noise caused as the disks 110 and 112 rotate in the HDD 100 may be formed of metal, such as aluminium or polymer resin. The disk damper 150 is inserted between the disks 110 and 112 and is spaced, at a predetermined interval, from the disks 110 and 112 so that the disks 110 and 112 do not come into contact with each other. The disk damper 150 is mounted and supported by first, second, and third supporting units 102, 103 and 104, respectively, formed on the base 101, by screws. The disk damper 150 is positioned to avoid the HSA 130 so as not to interrupt the movement of the HSA 130, and is designed in an alphabet character “C” shape.

A circulating filter 140 to filter foreign materials, such as particles contained in the air flowing inside the HDD 100, is positioned outside the circumference of the disks 110 and 112. The circulating filter 140 is supportedly inserted in a filter holder 106 arranged at one side of the cover 105. An FPC (flexible printed circuit) bracket 143 to connect a FPC 142 connected with the HSA 130 to a main circuit substrate (not shown) positioned under the base 101 is positioned at one side of the base 101 adjacent to the HSA 130.

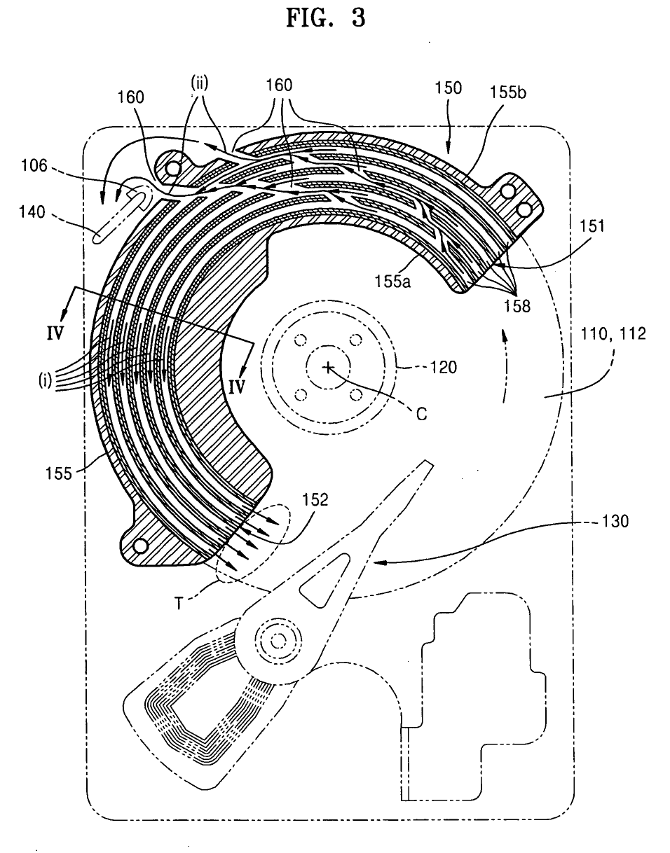

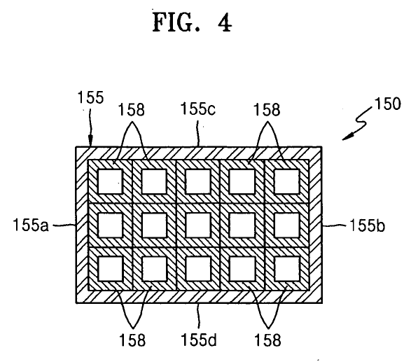

FIG. 3 is a cross-sectional view illustrating a disk damper according to an exemplary embodiment of the present general inventive concept as illustrated in FIG. 2, and FIG. 4 is a vertical sectional view illustrating the disk damper as taken along the line IV-IV of FIG. 3.

With reference to FIGS. 3 and 4, the disk damper 150 includes a damper body 155 to define an exterior shape of the disk damper 150 with inner and outer side walls 155a and 155b and upper and lower side walls 155c and 155d, and a plurality of pipes 158 disposed inside the damp body 155. The damper body 155 allows an air flow to flow into an inside of the damper body 155 and to flow out the damper body 155 through a front end 151 formed with an opening, positioned relatively far from the HSA 130, and a rear end 152 formed with a second opening, positioned relatively close to the HSA 130.

The plurality of pipes 158 are bent along a concentric circular arc having a same center as a rotation center C of the disks 110 and 112 and induce the air flow caused by the rotation of the disks 110 and 112 from the front end 151 to the rear end 152 through the inside of the disk damper 150. The plurality of pipes 158 inducing the air flow which flows into the front end 151 of the disk damper 150 and flows out the rear end 152 forms a first flow channel as indicated by arrows (i) illustrated in FIG. 3.

Since each of the plurality of pipes 158 have the same-sized square sections as illustrated in FIG. 4, it is possible to easily and firmly bond other adjacent pipes 158, and it is also possible to minimize a thickness of the disk damper 150 when the pipes 158 are layered so as to form a plurality of layers. The disk damper 150 according to the embodiment of FIG. 4 is formed in a manner that the plurality of pipes 158 are horizontally arranged in five columns and layered in three layers. The number of columns and the number of the layers may vary. However, pipes in different shapes, for example, pipes having a hexagonal section, respectively, may be included since the disk damper 150 of FIG. 4 does not limit the shape of pipes.

One or more apertures 160 are formed in the outer side wall 155b and the pipes 158 of the disk damper 150 such that the air flow caused by the rotation of the disks 110 and 112 is toward the circulating filter 140. The plurality of pipes 158 and apertures 160 form a second flow channel inducing the air flow flowing into the front end 151 of the disk damper 150 toward the circulating filter 140, as indicated by arrows (ii) shown in FIG. 3.

Accordingly, the pipes 158 forming the first flow channel may be separated from the pipes 158 forming the second flow channel, and may receive the air from the front end 151 and/or the apertures 160 formed between the first and second flow channels. The plurality of pipes 158 may be arranged in a radial direction of the rotation center C, and may include, for example, an inside pipe disposed adjacent to the inside wall 155a and away from the outside wall 155b in a first circumferential direction of the rotation center C and an outside pipe disposed away from the inside wall 155a and adjacent to the outside wall 155b in a second circumferential direction of the rotational center C. A first portion of the air flow flowing in the inside pipe may flow from the front end 151 to the rear end 152, and a second portion of the air flow flowing in the inside pipe may flow from the inside pipe toward the outside pipe and/or an intermediate end formed with opening, such as the apertures 160, so that the air from the inside pipe and the outside pipe can pass through the filter 40. The second portion of the air flow flowing from the inside pipe may be combined with at least one portion of the air flow flowing in the outside pipe.

A part of the air flow in the counter-clockwise direction caused by the rotation of the disks 110 and 112 flows into the plurality of pipes 158 at the front end 151 of the disk damper 150 and flows out through the rear end 152, along the first flow channel (i). Therefore, a flow width of the air flow is not rapidly reduced at the front end 151 and is not rapidly increased at the rear end 152. Consequently, the occurrence of a turbulent flow caused by flow disturbance at the front end 151 and the rear end 152 is controlled, the occurrence of a laminar flow is enhanced, and the vibration of the HSA 130 is reduced by the decrease in the flow disturbance at a wake region T adjacent to the rear end 152.

Further, since a part of the air flow flowing into the front end 151 is induced toward the circulating filter 140 along the second flow channel (ii), a flow rate of the air passing through the circulating filter 140 is increased such that particles-collecting efficiency by the circulating filter 140 can be improved.

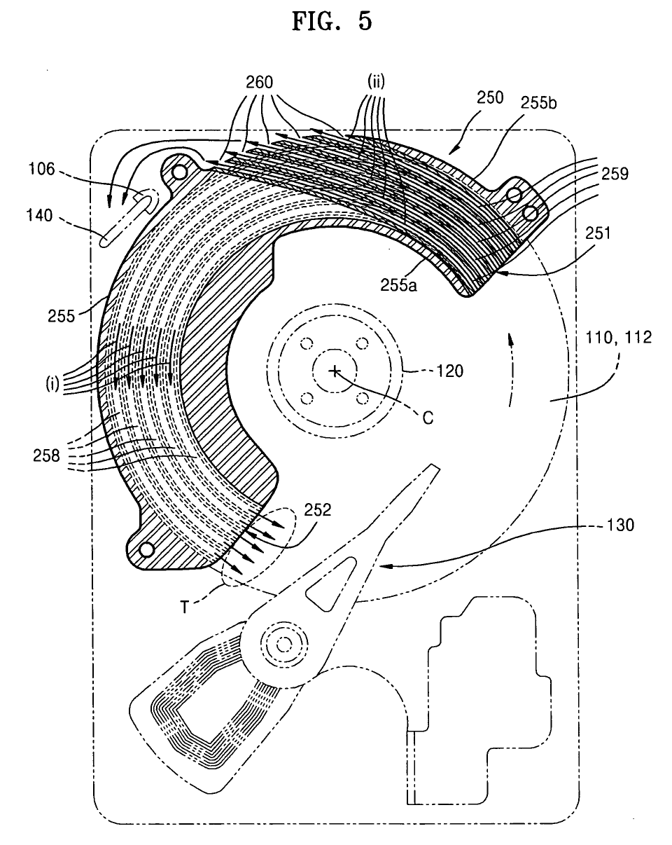

FIG. 5 is a cross-section view illustrating a disk damper 250 according to another embodiment of the present general inventive concept. The disk damper 250 according to the embodiment of FIG. 5 can replace the disk damper 150 illustrated in the HDD 100 according to the embodiment of FIG. 2.

In the same manner as the disk damper 150 according to the embodiment of FIGS. 3 and 4, the disk damper 250 according to the embodiment of FIG. 5 includes a damper body 255 in which inner and outer side walls 255a and 255b and upper and lower side walls (not shown) define an exterior shape, and a front end 251 and a rear end 252 are open for ventilation, and a plurality of pipes 258 and 259 arranged inside the damper body 255.

The plurality of pipes 158 and 259 are bent along a concentric circular arc having a same center as the rotation center C of the disks 110 and 112 and may include at least one first pipe 258 to induce the air flow caused by the rotation of the disks 110 and 112 from the front end 251 to the rear end 252 through the inside of the disk damper 250, and at least one second pipe 259 to induce the air flow flowing into the front end 251 toward the circulating filter 140. The first pipe 258 forms a first flow channel as indicated by the arrows (i) and the second pipe 259 forms a second flow channel as indicated by the arrows (ii). The first pipe 258 and the second pipe 259 can be layered to occupy different layers, respectively. For example, the pipes 258 and 259 can be layered by three layers inside the damper body 255, wherein the first pipe 258 is layered on the first and third layer and the second pipe 259 is layered on the second layer. One or more apertures 260 are formed in the outer side wall 255b of the damper body 255 such that the air flow flowing through the second pipe 259 exits the disk damper 250 and flows toward the circulating filter 140.

A part of the air flow in the counter-clockwise direction caused by the disks 110 and 112 flows into the first pipe 258 at the front end 251 of the disk damper 250 and flows out through the rear end 252, along the first flow channel (i). Therefore, the flow width of the air flow is not rapidly reduced at the front end 251 and is not rapidly increased at the rear end 252. Consequently, the occurrence of turbulent flow caused by flow disturbance at the front end 251 and the rear end 252 is controlled, the occurrence of laminar flow is enhanced, and the vibration of the HSA 130 is reduced by the decrease of the flow disturbance at the wake region T adjacent to the rear end 252.

Further, since another part of the air flow flows into the second pipe 259 and is induced toward the circulating filter 140 along the second flow channel (ii), the flow rate of the air passing through the circulating filter 140 is increased such that the particles-collecting efficiency by the circulating filter 140 can be improved.

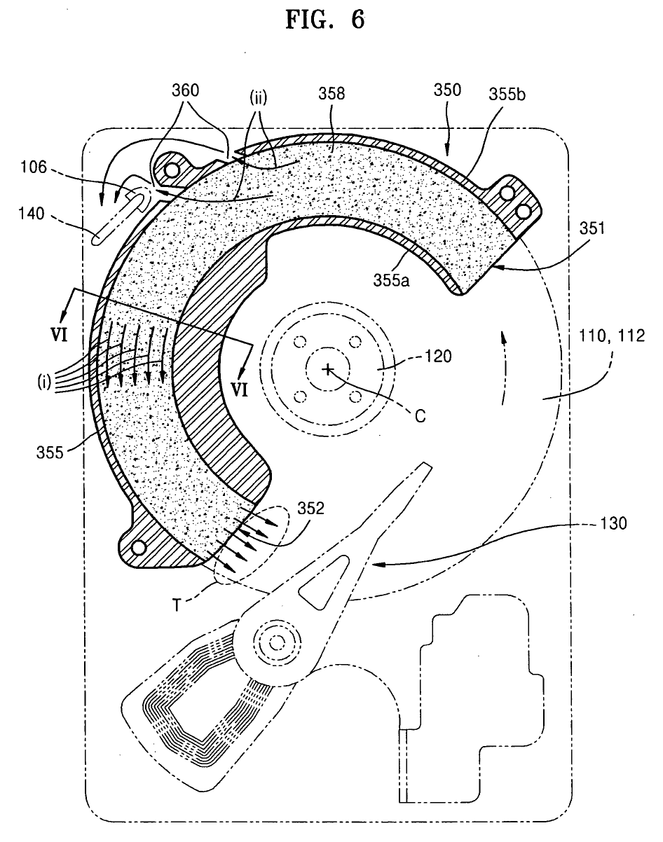

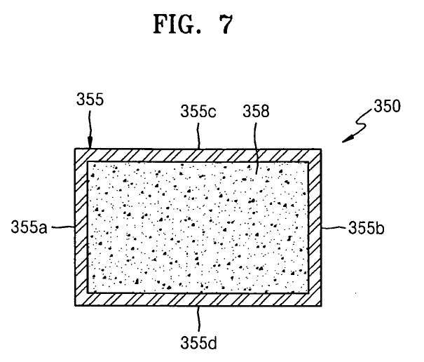

FIG. 6 is a cross-sectional view illustrating a disk damper 350 according to another embodiment of the present general inventive concept, and FIG. 7 is a vertical sectional view illustrating the disk damper 350 as taken along the line VI-VI of FIG. 6. The disk damper 350 according to the embodiment of FIG. 6 can replace the disk damper 150 illustrated in the HDD 100 according to the embodiment of FIG. 2.

With reference to FIGS. 6 and 7, in the same manner as the disk damper 150 according to the embodiment of FIGS. 3 and 4, the disk damper 350 according to the embodiment of FIG. 6 includes a damper body 355 in which inner and outer side walls 355a and 355b and upper and lower side walls 355c and 355d define an exterior shape, and a front end 351 and a rear end 352 are open for ventilation. An inside of the damper body 355 is filled with a porous material 358 permitting ventilation. The porous material 358 may be, for example, a metal net wherein a minute mesh is formed, woven fabric, or non-woven fabric. More specifically, the porous material 358 may be the material having a similar formation structure to the circulating filter 140. The porous material 358 filled inside the damper body 355 forms the first flow channel to induce the air flow flowing into the front end 351 to the rear end 352 through the inside of the disk damper 350, as indicated by the arrows (i).

one or more apertures 360 are formed at the outer side wall 355b of the damper body 355 such that the air flow flowing into the inside of the disk damper 350 through the front end 351 exits the disk damper 350 and flows toward the circulating filter 140.

When a part of the air flow in the counter-clockwise direction caused by the disk 110 and 112 flows into the inside of the disk damper 350 through the front end 351 of the disk damper 350 and passes through the porous material 358, it is laminarized and flows out through the rear end 352 along the first flow channel (i). Therefore, the flow width of the air flow is not rapidly reduced at the front end 351 and is not rapidly increased at the rear end 352. Consequently, the occurrence of turbulent flow caused by flow disturbance at the front end 351 and the rear end 352 is controlled, the occurrence of laminar flow is enhanced, and the vibration of the HSA 130 is reduced by the decrease of the flow disturbance at the wake region T adjacent to the rear end 352.

Further, since another part of the air flow flowing into the front end 351 exits the disk damper 350 through the apertures 360 and is induced toward the circulating filter 140, along the second flow channel (ii), the flow rate of the air passing through the circulating filter 140 is increased such that the particles-collecting efficiency by the circulating filter 140 can be improved.

According to the disk damper and the HDD having the same of the various embodiments of the present general inventive concept, the vibration of the HSA is reduced since the flow disturbance of the air in the wake region adjacent to the rear end of the disk damper is controlled. Accordingly, the speed of processing data by the HDD and the reliance thereon are improved, and the characteristics of a PES (position error signal) can be improved.

Furthermore, the particles-collecting efficiency by the circulating filter can be improved since the air flow toward the circulating filter is enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A disk damper to control vibration of a rotating disk, which is spaced, at a predetermined interval, from a disk in a hard disk drive and positioned not to interrupt a movement of a head stack assembly (HSA), the disk damper comprising:
a front end positioned relatively far from the HSA, and a rear end positioned relatively close to the HSA; and
a first flow channel to induce air flow caused by a rotation of the disk from the front end to the rear end, through an inside thereof.

2. The disk damper of claim 1, wherein the first flow channel comprises a plurality of pipes bent along a concentric circular arc having a same center as the rotation center of the disk.

3. The disk damper of claim 2, wherein the plurality of pipes have a same square or hexagonal section size, respectively.

4. The disk damper of claim 1, wherein the inside of the disk damper is filled with a porous material and the first flow channel is formed through the porous material.

5. The disk damper of claim 4, wherein the porous material comprises woven or non-woven fabric.

6. The disk damper of claim 1, wherein the hard disk drive comprises a circulating filter positioned outside a circumference of the disk, and the damper comprises a second flow channel to induce the air flow caused by the rotation of the disk from the front end toward the circulating filter.

7. A hard disk drive (HDD) which includes at least one disk as a data storing medium, a head stack assembly (HSA) to make a magnetic head that stores or reads out data to a specific position on the disk, and a disk damper spaced, at a predetermined interval, from the disk to control vibration of a rotating disk, and positioned not to interrupt a movement of an HSA, wherein the disk damper comprises:
a front end positioned relatively far from the HSA, and a rear end positioned relatively close to the HSA; and
a first flow channel to induce air flow caused by a rotation of the disk from the front end to the rear end through an inside of the disk damper.

8. The HDD of claim 7, wherein the first flow channel comprises a plurality of pipes bent along a concentric circular arc having a same center as a rotation center of the disk.

9. The HDD of claim 8, wherein the plurality of pipes have a same square or hexagonal section size, respectively.

10. The HDD of claim 7, wherein the inside of the disk damper is filled with a porous material permitting ventilation, and the first flow channel is formed through the porous material.

11. The HDD of claim 10, wherein the porous material comprises woven or non-woven fabric.

12. The HDD of claim 7, further comprising:
a circulating filter to filter foreign materials contained in air, outside the circumference of the disk,
wherein the disk damper further comprises a second flow channel to induce the air flow caused by the rotation of the disk from the front end toward the circulating filter.

13. The HDD of claim 7, wherein the disk comprises a plurality of disks stacked, and the disk damper is inserted between the adjacent disks.

14. The HDD of claim 7, wherein the disk comprises a single disk, and the disk damper is positioned above the disk.

15. A hard dick drive, comprising:
a disk; and
a disk damper disposed to control vibration of the disk, and having an front end formed with a front opening to receive air, and a rear end formed with a rear opening to output the air, and an intermediate end formed with one or more apertures and formed between the front end and the rear end to output the air to a portion between the front end and the rear end.

16. The HDD of claim 15, further comprising:
a circulating filter disposed around the disk to receive the air from the apertures of the intermediate end.

17. The HDD of claim 15, further comprising:
a porous material disposed in the disk damper between the front end and the rear end.

18. The HDD of claim 15, further comprising:
a base to rotatably support the disk, and having four corners,
wherein the front end and the rear end are disposed around two opposite corners, respectively, and the intermediate end is disposed around one of the four corners between the two opposite corners.

19. The HDD of claim 15, further comprising:
a head stack assembly having a swing arm and one or more heads disposed on a distal end of the swing arm,
wherein the front end is spaced apart from the one or more heads by a first distance and the rear end is spaced apart from the one or more heads by a second distance less than the first distance.

20. The HDD of claim 15, wherein a passage of the air from the front end to the rear end is formed in a circumferential direction of a rotation center of the disk, and a second passage of the air from the front end to the intermediate end is formed in a direction away from the rotation center of the disk.

21. The HDD of claim 15, wherein the disk damper comprises an inside wall and an outside wall to form an inside of the damper to provide a passage of the air, and the intermediate end is formed on the outside wall.

22. The HDD of claim 15, wherein the disk damper comprises an inside wall, and an outside wall, an inside pipe disposed adjacent to the inside wall, and an outside pipe disposed on the outside wall, and the one or more apertures comprises a first aperture formed on the inside pipe and the outside pipe to provide an air passage between the inside pipe and the outside pipe and a second aperture formed on the outside wall.

23. The HDD of claim 15, wherein the disk damper comprises a plurality of layers in a direction perpendicular to the disk, and the intermediate end is formed on one of the a plurality of layers.
